(19) United States
(12) Patent Application Publication
(10) Pub. No.: US 2010/0259606 A1
(43) Pub. Date: Oct. 14, 2010

(54) IMAGING DEVICE AND METHOD FOR CONTROLLING IMAGING DEVICE

(75) Inventor: Reiji Hasegawa, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/757,861

(22) Filed: Apr. 9, 2010

(30) Foreign Application Priority Data
Apr. 14, 2009 (JP) 2009-098148

(51) Int. Cl. H04N 7/18

(52) U.S. Cl. 348/81

(57) ABSTRACT

An imaging device includes an imaging unit configured to capture an image of a subject and obtain image data, a setting unit configured to set at least two shooting modes including an underwater shooting mode and a normal shooting mode, and a control unit configured to set a different initial value of a control amount of white balance according to whether a shooting mode set by the setting unit is the underwater shooting mode or the normal shooting mode, calculate the control amount of white balance based on the set initial value and the image data obtained by the imaging unit, and perform white balance control on the image data obtained by the imaging unit based on the calculated control amount.

### BACKGROUND OF THE INVENTION

1. Field of the Invention

The present invention relates to white balance control of an imaging device which can perform underwater photographing.

2. Description of the Related Art

In recent years, due to technical innovation and price reduction, imaging devices such as digital cameras and digital video cameras have been prevalent, and these cameras have been used to shoot an image under various environments and light sources. Under various light sources, the imaging device changes color of the light source close to white by auto white balance (hereinafter, white balance is referred to as WB and auto white balance is referred to as AWB) control to bring a photographing state close to a state in which a person is adapted to ambient light.

As one of various photographing environments, there is an underwater or undersea environment. Under water, a beam of light is steadily absorbed starting from a long wavelength side. Therefore, even though a light source is sunlight, an underwater photograph tends to become bluish in color. An imaging device which can bring a photographing state close to a state in which a person is adapted to ambient light by using AWB have been discussed (Japanese Patent Application Laid-Open No. 2008-17198).

However, the imaging device which performs the AWB control by feedback control and shoots an underwater photograph may not recognize white color since a light source has dark blue color which cannot be supposed on land. In this case, even if an AWB control range has a broad range corresponding to underwater blue color, the imaging device cannot perform the accurate AWB control. Further, even if white color is recognized, in the case of taking moving images, the imaging device controls so that a color change can be temporally gentle, and thus it takes a long time until it becomes an appropriate WB state.

### SUMMARY OF THE INVENTION

The present invention is directed to a technique capable of accurately and rapidly performing white balance control when an imaging device takes an underwater photograph.

According to an aspect of the present invention, an imaging device includes an imaging unit configured to capture an image of a subject and obtain image data, a setting unit configured to set at least two shooting modes including an underwater shooting mode and a normal shooting mode, and a control unit configured to set a different initial value of a control amount of white balance according to whether a shooting mode set by the setting unit is the underwater shooting mode or the normal shooting mode, calculate the control amount of white balance based on the set initial value and the image data obtained by the imaging unit, and perform white balance control on the image data obtained by the imaging unit based on the calculated control amount.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a block configuration of an imaging device according to the present invention.

FIG. 2 is a graph illustrating a control amount of R and B gains in AWB control according to the present exemplary embodiment.

FIG. 3 is a flowchart illustrating a flow of initial value setting according to the present exemplary embodiment.

FIG. 4 is a flowchart illustrating a flow of feedback control of white balance according to the present exemplary embodiment.

FIG. 5 illustrates an achromatic color detection range in a color space according to the present exemplary embodiment.

FIG. 6 illustrates a relationship between an initial value and a correction direction of a control amount according to the present exemplary embodiment.

### DESCRIPTION OF THE EMBODIMENTS

Various exemplary embodiments, features, and aspects of the invention will be described in detail below with reference to the drawings.

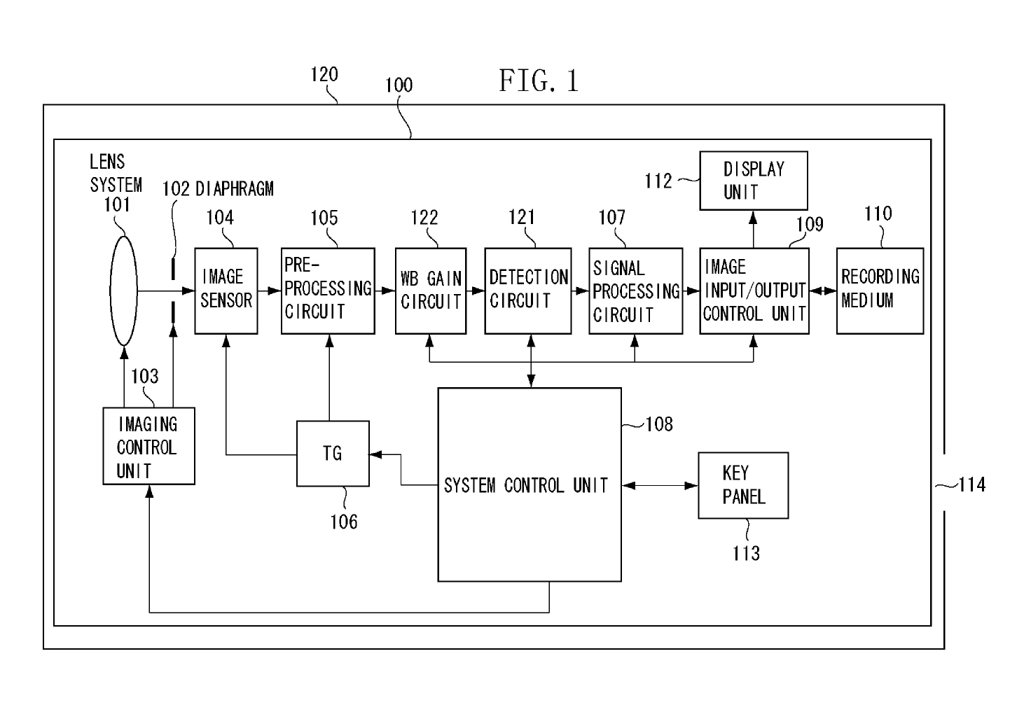

FIG. 1 illustrates a block configuration of an imaging device 100 according to the present invention. In FIG. 1, a lens system 101 may perform a zoom function and an auto focus function. A diaphragm 102 has a function of adjusting a quantity of light reaching an image sensor 104 and a shutter function of shielding the light to the image sensor 104. An image control unit 103 controls the zoom function and the focus function of the photographic lens system 101, and the light quantity adjusting function and the light-shielding function of the diaphragm 102.

The image sensor 104 is configured with a charge coupled device (CCD) sensor or a complementary metal oxide semiconductor (CMOS) sensor and converts a light-received subject image to image data including an electrical signal. A pre-processing circuit 105 includes a correlated double sampling (CDS) circuit, an automatic gain control (AGC) circuit, and an analog-to-digital (A/D) converter. A timing generator (TG) 106 generates a signal for controlling driving timing of the image sensor 104 and the pre-processing circuit 105 and controls the image sensor 104 and the pre-processing circuit 105.

A white balance (WB) gain circuit 122 can apply again of each color of red (R), green (G), and blue (B) for white balance control which will be described below. A detection circuit 121 detects an image for feedback control of white balance which will be described below. A signal processing circuit 107 performs gamma correction processing and color correction processing. A system control unit 108 is in charge of control of the whole imaging device 100.

An image input/output control unit 109 controls transmission and reception of image data to and from a display unit 112 and a recording medium 110. The recording medium 110 stores image data processed by the signal processing circuit 107 and includes a digital video (DV) tape, a digital versatile disc (DVD), or a memory card. The display unit 112 displays an image output from the image input/output control unit 109 and includes a liquid crystal display (LCD) or an organic electroluminescence (EL) display. A key panel 113 includes operation members such as a plurality of operation buttons, and a photographer can operate the imaging device 100 via the key panel 113.

An underwater housing 120 is a case having a waterproof function in which the imaging device 100 can be stored. The underwater housing 120 is removable from the imaging device 100 and has a material and a structure with the strength withstanding water pressure of a desired depth of water. Further, a portion around the lens system 101 is made of a material which has high transparency and the strength withstanding water pressure, and is anti-reflection processed, so as not to hinder a field of vision of the lens system 101 when the imaging device 100 shoots an image. In addition, the underwater housing 120 has an opening via which predetermined operation buttons among a plurality of operation buttons of the key panel 113 can be operated even in a state where the underwater housing 120 is mounted on the imaging device 100.

A user can operate a predetermined operation button via the opening to change a shooting mode, which will be described below, even in a mounting state of the housing 120. In the present exemplary embodiment, the imaging device 100 and the underwater housing 120 are separately configured, but the imaging device 100 may be configured to have a waterproof structure.

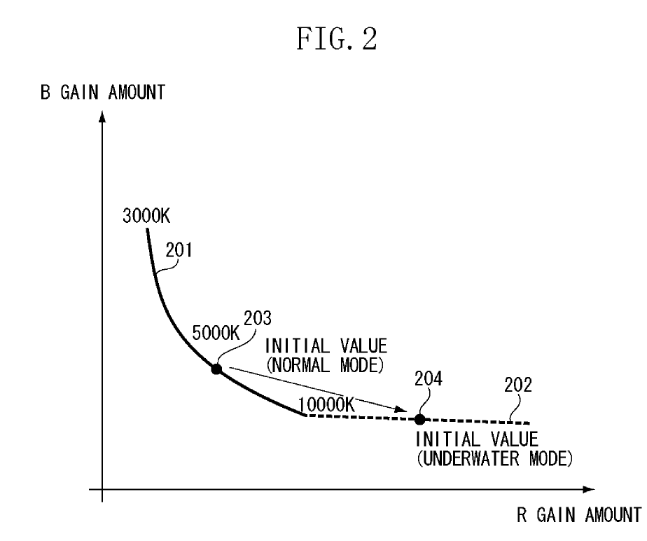

FIG. 2 is a graph illustrating a control amount of gains of R and B in the auto white balance (AWB) control according to the present exemplary embodiment.

The WB control according to the present exemplary embodiment is performed such that, among red, green, and blue (hereinafter, R, G, and B), G is fixed, and the control amount of gains of R and B is changed. In FIG. 2, a solid line denotes a variable range 201 of the control amount for a general light source on land according to black body radiation. A left upper portion of the solid line represents the control amount at color temperature of 3,000 K like a filament lamp or a halogen lamp. A gain amount of B is high, and a gain amount of R is low. A right lower portion of the solid line represents alight source of color temperature 10,000 K like a shade in fine weather. A gain amount of B is low, and a gain amount of R is high.

A dotted line 202 denotes a variable range of an underwater control amount. In the present exemplary embodiment, in a normal (land) shooting mode, the control amount is in the control range 201, whereas in an underwater shooting mode, the control amount extends from the control range 201 to the control range shown by the dotted line 202. Since a light source of low color temperature is not present under water, to prevent erroneous control, the control amount may be restricted not to be equal to or less than a predetermined value of the control range 201, for example, 5,000 K.

In the present exemplary embodiment, a mode capable of appropriately shooting an image in a land environment other than underwater shooting is defined as a normal shooting mode. The land environment includes various light source environments corresponding to the control range 201 such as fine weather, an evening view, a night view, and a fluorescent lamp.

In the present exemplary embodiment, the normal shooting mode and the underwater shooting mode are different in an initial value of the control amount. More particularly, when electric power is supplied to the imaging device 100 in a state in which the normal shooting mode is set in advance, the system control unit 108 sets the initial value to a point 203 on the control range 201. Further, when electric power is supplied in a state in which the underwater shooting mode is set in advance, the initial value is set to a point 204 on the control range 202.

The present invention is not limited to setting of the shooting mode at the time of supplying electric power. After supplying electric power, in a state in which the housing 120 is mounted as described above, the shooting mode may be changed in response to a user's operation input to a predetermined operation button of the key panel 113.

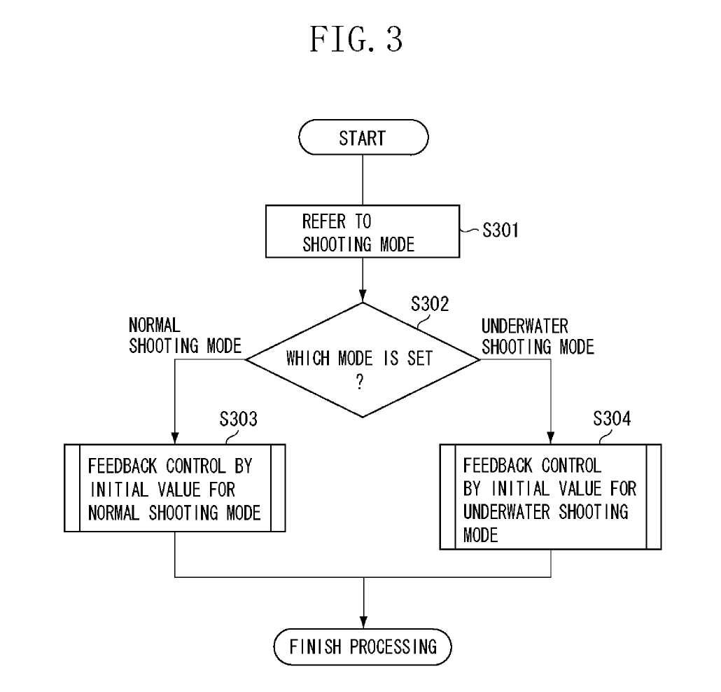

FIG. 3 is a flowchart illustrating a flow of initial value setting according to the present exemplary embodiment. The flowchart is executed by the system control unit 108 controlling the WB gain circuit 122 and the detection circuit 121.

In step S301, a set shooting mode is referred in response to power supply or an operation input by the user. In step S302, it is determined whether the shooting mode referred in step S301 is the normal shooting mode or the underwater shooting mode.

When the set shooting mode is the normal shooting mode, the processing proceeds to step S303. In step S303, the control amount at 5,000 K is set as the initial value of the normal shooting mode, and the feedback control of white balance is performed. On the other hand, when the set shooting mode is the underwater shooting mode, the processing proceeds to step S304. In step S304, the initial value 204 (the control amount which is sufficiently higher than 10,000 K in a blue direction) of the underwater shooting mode is set, and the feedback control of white balance is performed.

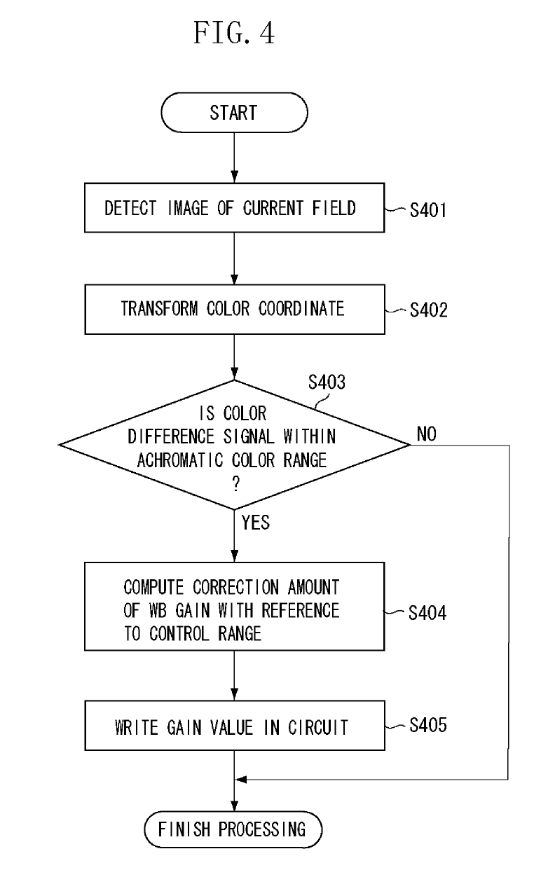

FIG. 4 is a flowchart illustrating a flow of the feedback control of white balance executed in steps S303 and S304 of FIG. 3. The flowchart is executed by the system control unit 108 controlling the WB gain circuit 122 and the detection circuit 121.

In step S401, the detection circuit 121 detects color of an image in a current field. As a method for performing detection, there are a method for using an average of the whole screen and a method for individually detecting each pixel, for example, a method for segmenting a screen into blocks of 16×8 and using a plurality of average values of each block. Any of the above methods may be used.

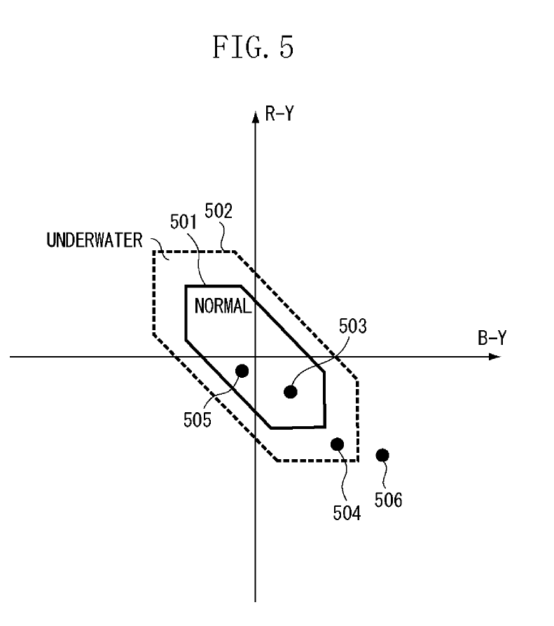

Next, in step S402, coordinate transformation of the detected color is performed. For example, even though image processing is performed with a coordinate system of (R, G, B) up to a previous stage, the detected color is transformed to a coordinate system of brightness Y and a color difference (R-Y, B-Y). More specifically, in the present exemplary embodiment, since a detection region of achromatic color is determined at a control axis of the color difference as in FIG. 5, the detected color needs to be matched with the coordinate system. Further, if the transformation is performed on each control axis, it may be transformed to a different coordinate system.

In step S403, it is determined in which detection range a color difference signal obtained by the coordinate transformation in step S402 is located.

FIG. 5 illustrates an achromatic color detection range in an (R-Y)-(B-Y) color space. A solid line 501 represents a region determined as the achromatic color in the normal shooting mode. A dotted line 502 represents a region determined as the achromatic color in the underwater shooting mode. The color of the light source away from the current WB control amount is difficult to be determined as the achromatic color, and the underwater WB control range is broadened as described in FIG. 2. Therefore, the detection range of the underwater shooting mode also needs to be broadened relative to the detection range of the normal shooting mode.

When a position of the color difference signal obtained in step S402 is within a range 501 like a point 503 of FIG. 5, the system control unit 108 stores in which direction the point 503 is located relative to centers of the two coordinate axes. This information is stored in, for example, a memory of the system control unit 108. A fact which is present in a minus direction to the R-Y axis direction and in a plus direction to the B-Y axis direction is stored, and the processing proceeds to step S404.

On the other hand, when a position of the color difference signal obtained in step S402 is not within the achromatic color range like a point 506 (NO in step S403), the system control unit 108 determines that the color is a color of the subject itself and finishes the processing.

When a position of the color difference signal obtained in step S402 is a point 504 and the shooting mode is set to the underwater shooting mode, the system control unit 108 stores a fact which is present in a minus direction to the R-Y axis direction and in a plus direction to the B-Y axis direction. On the other hand, if the shooting mode is set to the normal shooting mode (NO in step S403), it is determined as the color of the subject itself, and the processing is finished.

In step S404, the system control unit 108 determines a correction direction of white balance.

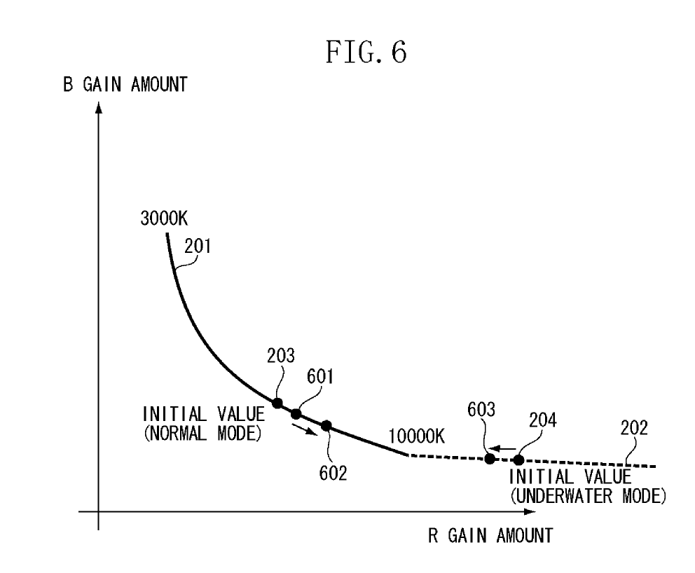

FIG. 6 illustrates a relationship between the initial value and the correction direction. The same lines and points as in FIG. 2 are denoted by the same reference numerals. An R gain and a B gain which are the current WB control amounts needed to be moved in a direction opposite to a color direction of FIG. 5 to correct the color of a current image in a white direction.

First, it is assumed that the shooting mode is set to the normal shooting mode and the initial value of the control amount is set to the point 203 of FIG. 6 to shoot an image on land, and then shooting is performed on land during predetermined time.

At this time, when a position of the color difference signal obtained in step S402 is the point 503, since the point 503 is in a minus R-Y direction and in a plus B-Y direction relative to an original point, it is necessary to increase the R gain and decrease the B gain. At this time, when a point 601 of FIG. 6 has the current WB control amount, in other words, a value in which the R gain and the B gain are combined, to increase the R gain and the B gain, a point 602 becomes the next control amount.

As another example, when a position of the color difference signal obtained in step S402 is a point 505, in step S404, the point 505 is in a minus R-Y direction and in a minus B-Y direction relative to the original point. Accordingly, it is necessary to increase the R gain and the B gain to make the color of the point close to the achromatic color. At this time, when the current WB control amount is the point 601, the R gain can be increased, but if the B gain is further increased, it is protruded from the line. Therefore, the only R gain is increased, and as a value of the B gain within the control range, the same point 602 is eventually set as the next WB control amount.

The above description is a control example in the land shooting condition. The shooting mode is set to the normal shooting mode, and the control from the current WB control amount is moved to an extent not to exceed a region of the solid line 201 of FIG. 6. Therefore, it is possible to correct the color of the light source which is commonly present in nature.

In the above example, a change from the point 601 to the point 602 is performed by one step. However, in the case of a moving image, when the WB control is quickly changed, uncomfortable feeling is caused when viewing the moving image. Therefore, a change in the WB control is slowly performed via a plurality of steps. Further, it may have slight hysteresis to avoid a hunting phenomenon.

On the other hand, it is assumed that the shooting mode is set to the normal shooting mode and the initial value of the control amount is set to the point 203 of FIG. 6 to shoot an image under water, and then underwater shooting is started. At this time, when a position of the color difference signal obtained in step S402 is the point 504, since it is not within the range for the normal shooting mode, the control according to the point is not performed.

However, it is assumed that the shooting mode is set to the underwater shooting mode and the initial value of the control amount is set to the point 204 of FIG. 6 in order to shoot an image under water, and then the underwater shooting is started. In this case, when a position of the color difference signal obtained in step S402 is the point 504, it is within the detection range 502 for the underwater shooting mode. Since the point 5504 is in a minus R-Y direction and in a plus B-Y direction relative to the original point, the control amount for moving the R gain in an increase direction and the B gain in a decrease direction, for example, the point 603 of FIG. 6, is set.

If it is assumed that the initial value of the control amount is at the position of the point 203, a distance on the control range between the point 203 and the point 603 is far. Further, as described above, when the change is slowly performed via a plurality of steps, it may take a long time to reach an appropriate WB state, and the control may not be appropriately performed. Therefore, in the present exemplary embodiment, in the underwater shooting mode, the initial value is set to the point 204, so that the feedback control can be rapidly and accurately performed.

Returning to the flowchart of FIG. 4, in step S405, the control amount determined in step S404 is written in the WB gain circuit 122. Therefore, the WB of an image in a next field is adjusted by the control amount calculated based on the current image detected in step S401. The feedback control for repeating the processing in the flowchart of FIG. 4 is performed, so that the color recognized as the achromatic color steadily becomes close to the achromatic color on the image.

As described above, according to the present exemplary embodiment, in the underwater shooting mode, the detection range of the achromatic color and the control amount variable range of the gain are increased more than in the normal shooting mode. Therefore, the white balance control suitable for underwater shooting can be performed. Further, the initial value for the underwater shooting mode is set independent of the normal shooting mode, and thus the control amount of the gain can be rapidly and accurately controlled.

The above exemplary embodiment has been described focusing on the case of shooting a moving image, but the present invention is not limited thereto, and the same technique can be applied to shooting a still image. Further, the present invention can be applied to a system which includes a plurality of devices. For example, previous blocks and latter blocks of the pre-processing circuit 105 may be configured in different housings.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-098148 filed Apr. 14, 2009, which is hereby incorporated by reference herein in its entirety.

What is claimed is:

1. An imaging device, comprising:
an imaging unit configured to capture an image of a subject and obtain image data;
a setting unit configured to set at least two shooting modes including an underwater shooting mode and a normal shooting mode; and
a control unit configured to set a different initial value of a control amount of white balance according to whether a shooting mode set by the setting unit is the underwater shooting mode or the normal shooting mode, calculate the control amount of white balance based on the set initial value and the image data obtained by the imaging unit, and perform white balance control on the image data obtained by the imaging unit based on the calculated control amount.

2. The imaging device according to claim 1, wherein the initial value of the underwater shooting mode is a control amount corresponding to a light source which exceeds a variable range of the control amount of white balance in the normal shooting mode, in a blue color direction.

3. The imaging device according to claim 1, further comprising:
an operation unit which includes a plurality of operation members and is configured to allow a user to perform an operation input thereby; and
an underwater housing which has a waterproof function for underwater shooting and is configured to include an opening via which a predetermined operation member among the plurality of operation members of the operation unit can be operated even in a state where the underwater housing is mounted on the imaging device,
wherein the setting unit sets the shooting mode to the underwater shooting mode in response to the user's operation input from the predetermined operation member.

4. The imaging device according to claim 1, wherein when the set shooting mode is the underwater shooting mode, the control unit sets, as a control range of the control amount, a range which is extended in the blue color direction relative to the control range in the normal shooting mode.

5. The imaging device according to claim 4, wherein when the set shooting mode is the underwater shooting mode, the control unit sets, as a detection range of an achromatic color for calculation of the control amount, a range which is expanded relative to a detection range of the normal shooting mode.

6. A method for controlling an imaging device which includes an imaging unit configured to capture an image of a subject and obtain image data, the method comprising:
setting at least two shooting modes including an underwater shooting mode and a normal shooting mode; and
setting a different initial value of a control amount of white balance according to whether the set shooting mode is the underwater shooting mode or the normal shooting mode, calculating the control amount of white balance based on the set initial value and the image data obtained by the imaging unit, and performing white balance control on the image data obtained by the imaging unit based on the calculated control amount.
